(19) United States
(12) Patent Application Publication
(10) Pub. No.: US 2007/0219814 A1
(43) Pub. Date: Sep. 20, 2007

(54) Publicly-Funded Privately Facilitated Access to Survival Resources Method

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/537,469

(22) Filed: Sep. 29, 2006

Related U.S. Application Data
(63) Continuation-in-part of application No. 11/384,037, filed on Mar. 17, 2006.
Application No. 11/384,037 is a continuation-in-part of application No. 11/394,350, filed on Mar. 30, 2006.
Application No. 11/394,350 is a continuation-in-part of application No. 11/279,333, filed on Apr. 11, 2006.
Application No. 11/279,333 is a continuation-in-part of application No. 11/379,929, filed on Apr. 24, 2006.
Application No. 11/379,929 is a continuation-in-part of application No. 11/381,247, filed on May 2, 2006.
Application No. 11/381,247 is a continuation-in-part of application No. 11/381,257, filed on May 2, 2006.
Application No. 11/381,257 is a continuation-in-part of application No. 11/381,265, filed on May 2, 2006.
Application No. 11/381,265 is a continuation-in-part of application No. 11/381,277, filed on May 2, 2006.
Application No. 11/381,277 is a continuation-in-part of application No. 11/383,022, filed on May 12, 2006.
Application No. 11/383,022 is a continuation-in-part of application No. 11/420,594, filed on May 26, 2006.
Application No. 11/420,594 is a continuation-in-part of application No. 11/421,694, filed on Jun. 1, 2006.
Application No. 11/421,694 is a continuation-in-part of application No. 11/423,594, filed on Jun. 12, 2006.
Application No. 11/423,594 is a continuation-in-part of application No. 11/425,043, filed on Jun. 19, 2006.
Application No. 11/425,043 is a continuation-in-part of application No. 11/426,231, filed on Jun. 23, 2006.
Application No. 11/426,231 is a continuation-in-part of application No. 11/456,472, filed on Jul. 10, 2006.
Application No. 11/456,472 is a continuation-in-part of application No. 11/461,605, filed on Aug. 1, 2006.
Application No. 11/461,605 is a continuation-in-part of application No. 11/461,624, filed on Aug. 1, 2006.
Application No. 11/461,624 is a continuation-in-part of application No. 11/462,795, filed on Aug. 7, 2006.
Application No. 11/462,795 is a continuation-in-part of application No. 11/462,845, filed on Aug. 7, 2006.
Application No. 11/462,845 is a continuation-in-part of application No. 11/464,751, filed on Aug. 15, 2006.
Application No. 11/464,751 is a continuation-in-part of application No. 11/464,764, filed on Aug. 15, 2006.
Application No. 11/464,764 is a continuation-in-part of application No. 11/464,775, filed on Aug. 15, 2006.
Application No. 11/464,775 is a continuation-in-part of application No. 11/464,788, filed on Aug. 15, 2006.
Application No. 11/464,788 is a continuation-in-part of application No. 11/464,799, filed on Aug. 15, 2006.
Application No. 11/464,799 is a continuation-in-part of application No. 11/465,063, filed on Aug. 16, 2006.
Application No. 11/465,063 is a continuation-in-part of application No. 11/466,727, filed on Aug. 23, 2006.
Application No. 11/466,727 is a continuation-in-part of application No. 11/466,953, filed on Aug. 24, 2006.
Application No. 11/466,953 is a continuation-in-part of application No. 11/470,156, filed on Sep. 5, 2006.
Application No. 11/470,156 is a continuation-in-part of application No. 11/531,651, filed on Sep. 13, 2006.
Application No. 11/531,651 is a continuation-in-part of application No. 11/532,461, filed on Sep. 15, 2006.
Application No. 11/532,461 is a continuation-in-part of application No. 11/535,021, filed on Sep. 25, 2006.
Application No. 11/535,021 is a continuation-in-part of application No. 11/535,282, filed on Sep. 26, 2006.

(51) Int. Cl. G06Q 10/00

(52) U.S. Cl. 705/1

(57) ABSTRACT

A private entity provides (101), prior to a civilly-catastrophic event having occurred, at least one survival resource. This private entity then provides for holding (102) this resource in readiness to facilitate serving public members who are affected by a subsequent civilly-catastrophic event. Then, in response to the occurrence of such an event, this private entity then provides access (108) to the aforementioned survival resource by public members in exchange for governmentally-based consideration. The survival resource in question can range as desired from a modest, limited offering to a full-scale “town.” These teachings also comprise providing (102), holding, and providing access (109) to non-survival resources.

### RELATED APPLICATIONS

This application claims the benefit of the filing date of U.S. Provisional Application No. 60/823,806 which is hereby incorporated in its entirety herein.

This comprises a continuation-in-part of each of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265;

SUBSCRIPTION-BASED CATASTROPHE-TRIGGERED RESCUE SERVICES FACILITATION METHOD AND APPARATUS as filed on May 2, 2006 and having application Ser. No. 11/381,277;

POSITIVE PRESSURE FILTRATION KIT APPARATUS AND METHOD as filed on May 4, 2006 and having application Ser. No. 11/381,677;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD as filed on Jun. 1, 2006 and having application Ser. No. 11/421,694;

SUBSCRIPTION-BASED PRE-PROVISIONED TOWABLE UNIT FACILITATION METHOD as filed on Jun. 12, 2006 and having application Ser. No. 11/423,594;

RADIATION-BLOCKING BLADDER APPARATUS AND METHOD as filed on Jun. 19, 2006 and having application Ser. No. 11/425,043;

PRIVATE CIVIL DEFENSE-THEMED TELEVISION BROADCASTING METHOD as filed on Jun. 23, 2006 and having application Ser. No. 11/426,231;

EMERGENCY SUPPLIES PRE-POSITIONING AND ACCESS CONTROL METHOD as filed on Jul. 10, 2006 and having application Ser. No. 11/456,472;

PRIVATE CIVIL DEFENSE-THEMED BROADCASTING METHOD as filed on Aug. 1, 2006 and having application Ser. No. 11/461,605;

METHOD OF PROVIDING VARIABLE SUBSCRIPTION-BASED ACCESS TO AN EMERGENCY SHELTER as filed on Aug. 1, 2006 and having application Ser. No. 11/461,624;

SUBSCRIPTION-BASED INTERMEDIATE SHORT-TERM EMERGENCY SHELTER METHOD as filed on Aug. 7, 2006 and having application Ser. No. 11/462,795;

SUBSCRIPTION-BASED CATASTROPHE-TRIGGERED RESCUE SERVICES FACILITATION METHOD USING WIRELESS LOCATION INFORMATION as filed on Aug. 7, 2006 and having application Ser. No. 11/462,845;

PRIVATELY PROVISIONED SURVIVAL SUPPLIES DELIVERY METHOD as filed on Aug. 15, 2006 and having application number 11/464,751;

PRIVATELY PROVISIONED SURVIVAL SUPPLIES SUB-UNIT-BASED DELIVERY METHOD as filed on Aug. 15, 2006 and having application Ser. No. 11/464,764;

PRIVATELY PROVISIONED SURVIVAL SUPPLIES ACQUISITION METHOD as filed on Aug. 15, 2006 and having application Ser. No. 11/464,775;

PRIVATELY PROVISIONED SURVIVAL SUPPLIES CONTENT ACQUISITION METHOD as filed on Aug. 15, 2006 and having application Ser. No. 11/464,788;

METHOD TO PRIVATELY PROVISION SURVIVAL SUPPLIES THAT INCLUDE THIRD PARTY ITEMS as filed on Aug. 15, 2006 and having application Ser. No. 11/464,799;

WASTE DISPOSAL DEVICE as filed on Aug. 16, 2006 and having application Ser. No. 11/465,063;

SUBSCRIPTION-BASED PRIVATE CIVIL SECURITY RESOURCE CUSTOMIZATION METHOD as filed on Aug. 23, 2006 and having application Ser. No. 11/466,727;

PREMIUM-BASED PRIVATE CIVIL SECURITY POLICY METHODS as filed on Aug. 24, 2006 and having application Ser. No. 11/466,953;

SUBSCRIPTION-BASED MOBILE SHELTER METHOD as filed on Sep. 5, 2006 and having application Ser. No. 11/470,156;

METHOD OF PROVIDING A FLOATING LIFE-SUSTAINING FACILITY as filed on Sep. 13, 2006 and having application Ser. No. 11/531,651;

PRIVATELY PROVISIONED SUB-UNIT-BASED SURVIVAL SUPPLIES PROVISIONING METHOD as filed on Sep. 15, 2006 and having application Ser. No. 11/532,461;

PRIVATELY PROVISIONED INTERLOCKING SUB-UNIT-BASED SURVIVAL SUPPLIES PROVISIONING METHOD as filed on Sep. 25, 2006 and having application Ser. No. 11/535,021; and

RESOURCE CONTAINER AND POSITIONING METHOD AND APPARATUS as filed on Sep. 26, 2006 and having application Ser. No. 11/535,282; the contents of each of which are fully incorporated herein by this reference.

### TECHNICAL FIELD

This invention relates generally to providing one or more civil security resources to one or more members of the public.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related interactions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swatch of a given civil community. Any number of natural and/or non-naturally-caused events can sufficiently disrupt society's infrastructure and ability to provide one or more life-sustaining resources such as hydration, nutrition, shelter, and the like.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a civilly-catastrophic event occurs.

Such insights, of course, are not particularly new. Civil preparedness shortcomings occasionally attract public attention and niche marketing opportunities exist with respect to provisioning the needs of so-called survivalists. Indeed, there are those who spend a considerable amount of their time and monetary resources attempting to ready themselves to personally survive a civilly-catastrophic event. Therein, however, lies something of a conundrum.

On the one hand, modern governments typically do little to proactively ensure the bulk survival (let alone the comfort) of their citizens in the face of most civilly-catastrophic events. On the other hand, attempting to take responsible actions to reasonably ensure one's own safety and security can become, in and of itself, nearly a full-time avocation and leave little time to actually enjoy the conveniences and opportunities of modern life. Such individual actions may even be frowned upon by the greater part of society which has grown accustomed and falsely secure with existing efficient just-in-time delivery systems that provide the illusion of plenty while undercutting the perception of risk.

### BRIEF DESCRIPTION OF THE DRAWINGS

The above needs are at least partially met through provision of the publicly-funded privately facilitated access to survival resources method described in the following detailed description, particularly when studied in conjunction with the drawings, wherein:

FIG. 1 comprises a flow diagram as configured in accordance with various embodiments of the invention;

FIG. 2 comprises a schematic view as configured in accordance with various embodiments of the invention; and

FIG. 3 comprises a schematic view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a private entity provides, prior to a civilly-catastrophic event having occurred, at least one survival resource. This private entity then provides for holding this resource in readiness to facilitate serving public members who are affected by a subsequent civilly-catastrophic event. Then, in response to the occurrence of such an event, this private entity then provides access to the aforementioned survival resource by public members in exchange for governmentally-based consideration.

The survival resource in question can range as desired from a modest, limited offering to a full-scale “town” that is configured and arranged to provide many or all of the survival requirements of a dispossessed population of public members. These teachings will also readily accommodate providing, holding, and providing access to non-survival resources (that is, resources that are not necessary to ensure human survival but that may offer one or more benefits and/or meet one or more needs or preferences of such an audience).

The governmentally-based consideration can be comprehensive and cover essentially all material and services provided to such public members or can provide, if desired, only partial coverage in this regard. Accordingly, if desired, such access may be partially based upon further consideration as offered from another source. This other source may comprise the recipient public member, a benefactor (where the benefactor provides funds on a designated or a general basis based, for example, upon a grant of a specific dollar amount, a specific quantity of provided survival resources, a specific duration of time during which a beneficiary can access such survival resources, and so forth), an insurance provider, a civil security benefits underwriter, and so forth.

So configured, public members will have concrete, predictable access to at least one survival resource upon the occurrence of a civilly-catastrophic event. The selection and quantity of such survival resources can be generally selected (and their maintenance governed) by experts and hence relieve the public and its governing bodies of responsibility in this regard.

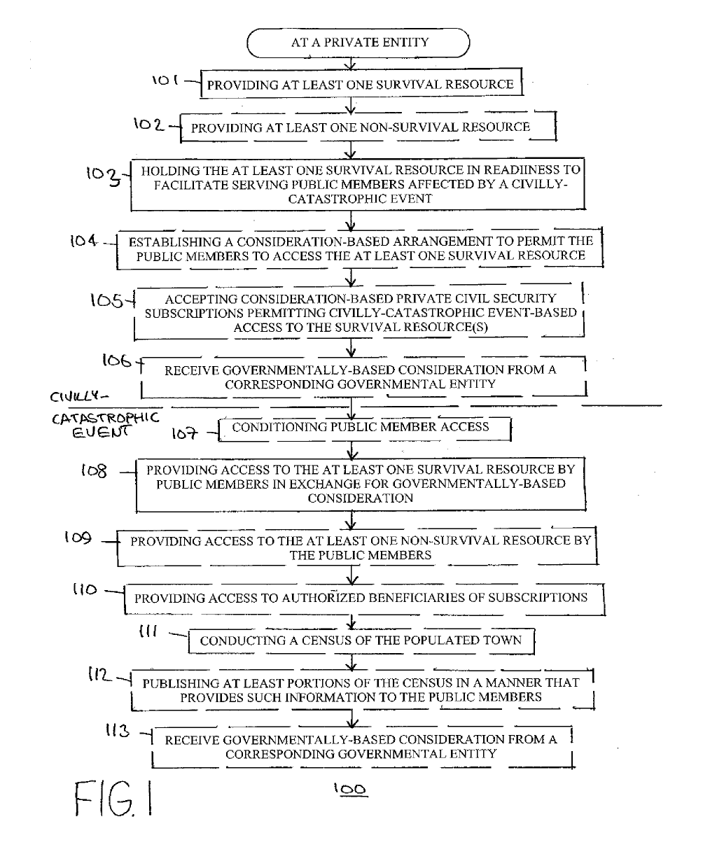

These and other benefits may become clearer upon making a thorough review and study of the following detailed description. Referring now to the drawings, and in particular to FIG. 1, a corresponding process provides for certain actions to transpire prior the occurrence of an applicable civilly-catastrophic event. This can comprise, in part, providing 101, via a private entity, at least one survival resource. This private party can comprise, for example, a provider of private civil defense services to various parties under various approaches in addition to those set forth herein. By this approach, the private party can comprise an expert with respect to identifying, selecting, vetting, acquiring, aggregating, storing, providing, designing, building, and/or maintaining a variety of survival resources. This private entity may comprise a for-profit enterprise or a not-for-profit enterprise. This notion of a “private” entity will be understood to encompass publicly-held enterprises such as corporations that have a dispersed ownership interest via publicly traded stock. Those skilled in the art will understand that as used herein, “private” refers to the opposite of a governmental body, branch, agency, or representative arm thereof.

This survival resource can comprise any one of food, hydration supplies (such as water or other consumable fluids), shelter, clothing, transport away from a location of substantial civil distress, rescue from civilly-catastrophic event-based substantially immediate threats (such as, but not limited to, drowning, exposure to a deadly influence, conflagration, violent civil disturbance, and so forth), environmentally borne threat abatement (such as protection from nuclear, biological, and/or chemical threats), medical facilities, and so forth.

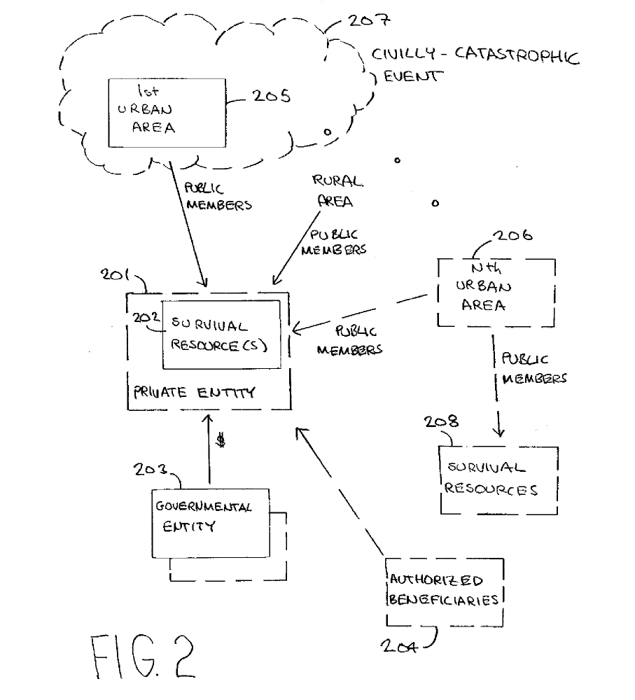

With momentary reference to FIG. 2, this survival resource (or survival resources) 202 as are provided by a given private entity 201 can be provided on land, on a floating platform (such as a boat(s), a barge(s), or an artificial island(s) located, for example, within a large body of water such as one of the Great Lakes, an ocean, and so forth), or elsewhere as may be appropriate to the anticipated needs and requirements as will likely attend a given application scenario. By one approach, such a survival resource 202 can be placed relatively proximal to a given urban area 205 (or plurality of urban areas 206). Undue proximity, of course, may increase a risk that the refuge represented by the survival resource 202 will itself be imperiled by a same civilly-catastrophic event 207 as may be visited upon such an urban area 205.

Accordingly, for many application settings it may be preferable to provide this survival resource 202 further away from rather than closer to such a location. For example, it may be useful to locate such a survival resource 202 many hundreds of miles away from any urban area. It may also be appropriate to consider other sources of risk in this regard. For example, it may be useful to locate such a survival resource 202 a safe distance away from other natural or non-natural threats as may potentially be predicted to occur in the future. To illustrate, this might mean placing such a survival resource 202 in a location that is well removed from any geological faults and that is generally in an area that experiences few devastating storms (such as hurricanes, tornados, or the like).

Referring again to FIG. 1, this process 100 will optionally accommodate also providing 102 at least one non-survival resource. This can comprise any of a variety of items and/or services ranging from useful to fanciful. Illustrative examples will be provided herein where appropriate.

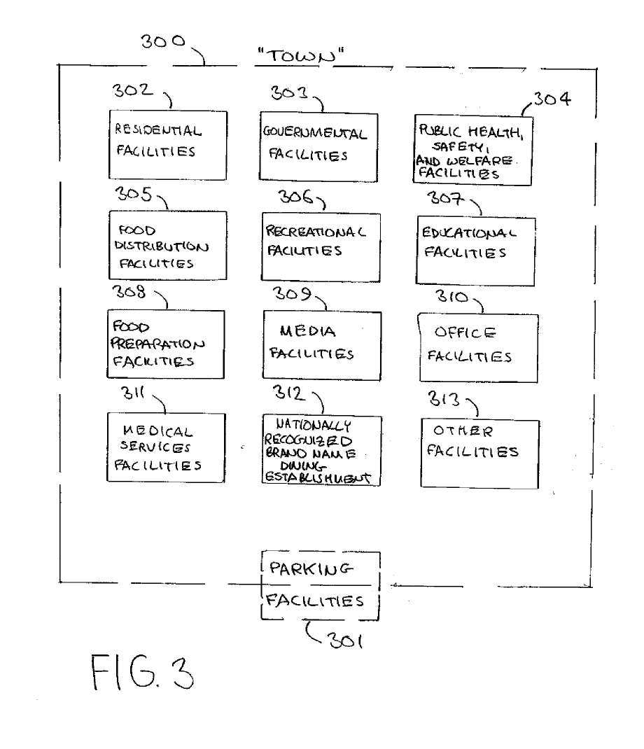

Referring now momentarily to FIG. 3, by one approach this step of providing at least one survival resource can comprise providing a substantially unpopulated town 300. (Those skilled in the art will recognize and understand that, as used herein, “town” serves as a convenient moniker for and reference to a municipality of essentially any size and serves as a representative expression for so-called villages, towns, cities, and so forth.) This town 300 can be built in the first instance as such an entity or can, if desired, comprise a previously populated town that has been largely abandoned for whatever reason. For example, if desired, the occupants of an existing town can agree to sell their real estate holdings and other corresponding property interests to the aforementioned private entity as one means of achieving this result.

In keeping with the teachings set forth above, this substantially unpopulated town 300 may be located a significant distance from a population body that becomes afflicted by a civilly-catastrophic event. In such a case, these dispossessed public members must be transported, one way or the other, to this substantially unpopulated town 300 in order to gain access thereto. This, in turn, can lead to a considerable number of vehicles being driven to the town 300. If desired, a parking facility 301 (which may comprise a single integrated parking facility or may comprise a plurality of physically segregated parking facilities) can be provided to accommodate such vehicles as are used by such public members to reach the town 300.

By one approach, this parking facility 301 can comprise a secure facility that is configured and arranged to substantially discourage unauthorized parties from making unauthorized access to vehicles contained in that facility. Various means are known to accomplish such a result. Some examples include the use of fencing or other perimeter barriers, locked and/or guarded points of access, lighting, security cameras, trained dogs, intrusion-detection alarm systems, and so forth. It would also be possible to provide valet services at such a facility. By this approach, the valet personnel would place the vehicles in the parking facility and/or would retrieve such vehicles that have been placed in the parking facility when needed.

The parking facility 301 may lie within the boundaries of the town 300, in whole or in part, or may lie outside those boundaries as desired. The parking facility 301 may comprise, in whole or in part, a below-ground facility, an above-ground facility, and/or a multi-level facility. Such architectural options for a parking facility are known in the art and require no further elaboration here.

It would also be possible for such a town 300 to further comprise, or be located relatively near, one or more airstrips. Such an airstrip could be provided and maintained solely for the use of the town 300 or could be used for other purposes as desired. Such an airstrip could comprise a minimal facility (featuring, for example, only a relatively flat surface upon which aircraft can land, takeoff from, and taxi upon) or can be well appointed as desired (for example, such an airstrip could be provided with hangers, maintenance facilities, a refueling capability and stores, emergency landing capabilities, a control tower, radar, and so forth). Such a facility could of course serve during a time of need as a way of receiving dispossessed persons who are seeking sanctuary at the town 300.

There are, of course, other ways by which such members of the public can make their way to such a facility during a time of need. Various terrestrial vehicles (such as the previously mentioned cars as well as busses, trains, and the like) can serve in this manner. It would also be possible to locate the town on or near a navigable body of water (such as a river, a canal, a lake, or an ocean) to thereby allow such persons to reach the town 300 by boat or the like.

This town 300 can comprise any of a variety of urban amenities. This town 300 can comprise, for example, residential facilities 302. Such residential facilities 302 can comprise sleeping accommodations. These sleeping accommodations can vary with any of a variety of factors and may comprise one or more of cots, bunk beds, a barracks facility (where a relatively large number of single level or multi level beds are provided to accommodate a corresponding number of people), a semi-private facility (such as a room having only two, three, or four beds), a private facility (such as a room having only one bed), and so forth. Similarly, the residential facilities 302 themselves can include other optional accommodations such as kitchens, dining areas, entertaining/meeting areas, storage areas, bathing and toilet areas, and so forth. These, in turn, can assume any of a wide variety of housing options including single family homes of various sizes, bungalows and townhomes, apartments, barracks, dormitories, and so forth.

This town 300 can further comprise governmental facilities 303. Such governmental facilities 303 can comprise, by one approach, suitable facilities for a local pre-provided government as offered by, for example, the aforementioned private entity. By another approach, these facilities can serve to house the governmental representatives who correspond to at least some of the disposed persons who will be sheltered within this town 300 during a time of need. For example, when a particular city is afflicted by a civilly catastrophic event and a significant portion of that city's population takes refuge in this town 300, the mayor, council persons, and other elected and/or appointed officials for that city can continue their elected/appointed roles by occupying and using these governmental facilities 303.

This town 300 can further comprise public health, safety, and welfare facilities 304. These facilities, too, can serve in various ways depending upon the needs and/or opportunities presented in a given application setting. By one approach these facilities can support the operations of a local police force, a fire fighting force, and local ambulance service as may be provided or otherwise permitted by the private entity that provides this town 300. By another approach, these facilities can support the operations of such service providers as may find themselves transplanted due to a civilly-catastrophic event.

This town 300 can also comprise food distribution facilities 305. There are, again, various ways by which such a capability can be met. By one approach this food distribution facility 305 can comprise a warehouse and/or distribution center for providing prepared or unprepared food and/or meals to town inhabitants. If desired, these food distribution facilities 305 can include a dining area. Also if desired, these food distribution facilities 305 can be pre-provisioned with a substantial quantity of food prior to the occurrence of a civilly-catastrophic event. This might comprise, for example, a one year supply of food for a given maximum intended population of the town 300 during a time of need. It would also be possible to plan to re-provision these stores from those resources to which the private entity may have access.

Such a town 300 can also be configured and arranged to provide both recreational facilities 306 (such as fitness centers, participatory and spectator sporting venues, clubhouses, and so forth) and educational facilities 307 (such as both on-line and in-person instructional facilities). These educational facilities 307 can comprise, for example, schools that can provide accredited academic instruction for school age public members. Such educational facilities 307 can also be configured and aimed to provide adult education and training. This, in turn, could be useful when training dispossessed persons for new jobs or professions as may be necessary or useful when responding to the aftermath of a given civilly-catastrophic event.

By one approach, food provided within the town 300 can comprise pre-prepared items such as meals-ready-to-eat as typify military fare in the field. If desired, however, in addition to such offerings or in lieu thereof the town 300 can further comprise food preparation facilities 308 where food offerings can be prepared. This can comprise food cleaning areas, cutting surfaces and tools, as well as one or more food heating tools (such as ovens, stoves, microwave ovens, toasters, grills, and so forth).

This town 300 can also comprise media facilities 309 if desired. These media facilities 309 can serve to facilitate the publication of a news report that can comprise any one or more of a local newspaper (including a newsletter), a local radio broadcast, a local televised broadcast, a local so-called podcast, data network-sourced streaming content, a local magazine, and other electronic and/or hardcopy publications of a periodic and/or non-periodic nature. These facilities can serve, for example, to inform the town's inhabitants (and/or others who are outside the town) regarding local and external news, information, activities, opportunities, and actions being taken on their behalf.

This town 300 can further comprise, if desired, office facilities 310. This, in turn, can serve to permit at least some dispossessed public members to have an opportunity to continue to ply their professions. Such office facilities can comprise, for example, computers, an extranet interface (such as a network connection to the Internet), two-way long distance voice-based communication apparatus (such as standard and conference-capable telephony, video conferencing, and so forth), printers, scanners, facsimile transceivers, typewriters, as well as electricity to power these and other items. These facilities can also comprise, if desired, providing individual private office space (up to and including multi-room office complexes), individual open office spaces (such as open cubicle configurations), shared office space, office furniture, group meeting facilities, administrative support, and/or office supplies of various kinds.

This town 300 can also comprise medical services facilities 311. These can be as minimal or as extensive as may be desired. Examples include but are not limited to first aid and first responder capabilities, general practice and/or specialty practice services, diagnostic capabilities of various kinds, therapeutic and treatment facilities, surgical facilities, dental care facilities, and so forth. If desired, particular facilities, professionals, medications, and the like as may pertain to particular conditions that are likely to afflict persons who have experienced particular civilly-catastrophic events and/or the rigors of fleeing such an event can be provided in a proportion that would otherwise likely be unusual in a more ordinary setting. For example, a larger number of respirators might be pre-provided than would ordinarily be expected for a given number of people. It would also be possible for such medical services facilities 311 to provide incoming dispossessed public members with an opportunity to apply for rapid replacement of lost prescription medicines. This might comprise, for example, providing a small limited supply of the identified medicine while working to quickly vet the right of the individual in question to rightfully receive the medicine in question in greater quantities.

It is possible that such a town 300 will serve as the home for a dispossessed number of people for a considerable period of time. As a part of meeting the needs and expectations of such a group it may be useful to provide one or more nationally recognized brand name dining establishments 312. (As used herein, it will be understood that “dining” refers to both food and beverage service and consumption facilities and can further include both sit-down dining facilities as well as carry-out and/or delivery services.) Such establishments can serve in a variety of ways to ease the experiential difficulties of dispossessed persons. For example, the availability of such facilities can provide a sense of familiarity and a touch of home. (With this in mind, it is also possible for such a town 300 to further comprise at least one nationally recognized brand name retail establishment, a nationally recognized brand name personal services establishment (such as, but not limited to, a hair dresser or stylist, a barber, a tax preparation facility or other financial services provider, and so forth), a nationally recognized brand name entertainment establishment (such as a theater chain, a gaming facility, or the like), and so forth.)

Such a town 300 can also comprise any number of other facilities 313. Some examples include, but are certainly not limited to:

Insurance claim adjustment facilities to permit insurance company claim adjusters to meet with their customers who have suffered losses as a result of a civilly-catastrophic event to facilitate the timely and efficient processing of those losses;

Financing services facilities to permit the public members to be able to arrange for financing (by one approach, this can comprise disaster area-based loan processing facilities to permit town inhabitants to conveniently process their corresponding disaster area-based loans as relate to the circumstances that they have endured as a result of a civilly-catastrophic event);

Voting facilities (including but not limited to absentee voting facilities) to permit and facilitate town inhabitants to be able to conveniently and reliably exercise their voting franchise in a timely manner notwithstanding their having been dispossessed to a distant venue as a result of a civilly-catastrophic event;

Retail stores offering any of a variety of typical and/or atypical consumer and non-consumer fare (including such things as clothing, tools, entertainment products, appliances, and furniture and other housing accoutrements as well as other items that may be more particularly related to the nature of the civilly-catastrophic event suffered by such individuals or to the aftermath as corresponds thereto);

Theatrical and performing arts venues (including both cinematic theaters and playhouses that offer live performances of various kinds);

A service facility to provide social security benefits services of various kinds;

A package delivery service (including delivery to external addresses as well as within the town itself);

Banking services (including asset transfers, check issuance and processing, credit card issuance and processing, loan processing, safe deposit boxes, and so forth);

Money transfer services (such as wired money transfer services);

Postal services (including delivery to and from external addresses as well as within the town itself);

Welfare services (as may be sourced and supported by a host region from where one or more of the town inhabitants hails from, by a national government, by the town itself, and so forth);

Immigration services (as may relate to legitimizing the entry of the town inhabitants to the town, a region within which the town is located, or to a subsequent destination of such inhabitants);

Passport services (as may relate to issuing and obtaining a passport in the first instance or to replacing a loss passport);

Bakery services;

Salon services;

Travel service services (including both local services, such as taxi service, as well as travel agent services to arrange for travel from the town to or from other locations);

Pharmaceutical services;

Grocery services (including self serve and/or delivery-based services);

Hair care services;

Laundry services (including both do-it-yourself and/or drop-off services);

Dry cleaning services;

Florist services;

Gift shop services;

Grief counseling services;

Funeral home services;

Bill payment services (to assist, for example, dispossessed persons to remain current with their bill payment obligations and/or to otherwise contact the entities to whom amounts are owed to make corresponding arrangements for payment (in a lump sum or over time), for postponement of repayment obligations, for renewed or modified financing, or the like);

An Internet café (which may or may not serve food and/or beverages but where town inhabitants can gain access to the Internet or other communications network via a provided wireless and/or wired access portal (using their own or provided equipment);

Law enforcement services (to support, for example, processing and investigating each town entrant with respect to outstanding warrants, probationary status, sex offender status, or the like to ensure their proper handling and the like);

A jail or other like facility to provide for the secure, humane retention of persons in need of such restraint;

A re-credentialing facility to assist town inhabitants with respect to regaining presently unavailable identity-related materials (such as, but not limited to, drivers licenses, social security cards, disabled-persons placards, credit cards, debit cards, state identification cards, medical insurance cards, firearms identifications cards (including but not limited to firearms concealed carry cards), and so forth);

One or more workshops (which may or may not be located within an industrial area of the town) where town inhabitants can provide labor as pertains, for example, to manufacturing at least one resultant manufactured item or providing at least one resultant service (and where, for example, a governmental entity has offered guarantees regarding an ensured purchase of this output) to thereby provide a way for dispossessed persons to find gainful employment during their stay in the town (and where, for example, such labor can serve to offset, if desired, consideration that might be owed to the private entity for whatever reason);

An expansion capability to support a greater than ordinary capacity of inhabitants (where, for example, the town has an ordinary planned capacity of 100,000 inhabitants but where the essential infrastructure is over-engineered to accommodate, say, twice that number and where additional deployable resources, such as tents, cots, inflatable mattresses, sleeping pads (made, for example, of a foam-like material), sleeping bags, loose bedding, tatami mats, or the like are stored on-site or nearby in order to provide some base level of deployable accommodations for dispossessed persons in excess of that ordinary planned capacity;

Maintenance facilities of a kind and extent to permit the town to essentially comprise, for all intents and purposes, an internally self-sufficient facility with respect to the ongoing functionality of its infrastructure elements (where such facilities can include tools, spare parts, replacement units, diagnostic equipment, instructional and training material, maintenance vehicles, and so forth);

Storage facilities where possessions of the inhabitants can be stored and/or where other facilities of the town can temporarily hold items; and/or

An inclusive two-way communications infrastructure (which may comprise a wireless or non-wireless system, in whole or in part) to facilitate remote communications between and amongst the inhabitants of the town and/or with other persons located outside the town;

to note but a few examples in this regard.

The size, number, and extent of these and other accommodations, and indeed the physical size of the town itself can vary as desired. To be reasonably viewed as a “town” as versus merely a shelter, such a town should likely be of sufficient size and accommodations to be capable of reasonably accommodating from, say, about 100 to 1,000,000 people. Such a facility could of course be planned to hold more than this upper number, but in such a case it may be prudent to provide a greater number of multiple towns rather than a fewer number of extremely large such facilities.

As described, this town is initially provided as a substantially unpopulated entity. This would, of course, include a fully unpopulated town. In many cases, however, it will be useful to pre-populate such a town with a relatively small number of persons. Such persons can attend, for example, to maintaining the readiness of the facility to receive incoming public members, to protecting the facility against unauthorized entry, and to otherwise ensure that the facility remains available for use when needed.

By one approach, this can comprise providing a number of persons as may be necessary to at least substantially fully staff some or all of an available number of service positions. This can comprise a relatively modest approach, as where only initially critical services (such as incoming persons processing, food services, and so forth) are so staffed or can comprise a more aggressive approach, as where a relatively large number of, or even all, services as will be rendered available to inhabitants are pre-staffed in this manner. If desired, a skeleton crew can be provided on an ongoing basis with fuller staffing being provided in anticipation of at least some civilly-catastrophic events. If and as such a threat diminishes, some or all of these additional positions can be scaled back. (If desired, in response to the civilly-catastrophic event having occurred, these teachings will also accommodate using at least some of the public members to facilitate at least one of the facilities of the town. This can comprise, at least in part, at least one of interviewing at least some of the public members regarding their qualifications to assist with at least one of the facilities, testing at least some of the public members regarding their qualifications to assist with at least one of the facilities, and/or training at least some of the public members to assist with at least one of the facilities.)

By one approach, if desired, at least one such resident can comprise an agent (such as an employee, a contractor, or the like) of the aforementioned private entity. For example, this resident can comprise an official for the substantially unpopulated town such as a member of a governmental branch (such as the executive branch, the legislative branch, the judicial branch, or some other public services entity such as, but not limited to, law enforcement or the like). By this approach, such a town can have a working governmental capability even before being populated, temporarily or otherwise, by a dispossessed group of public members.

In any event, and referring again to FIG. 1, regardless of whether the provided survival resource (and non-survival resource when provided) comprises a substantially unpopulated town or something less extensive, this process 100 then provides for holding 103 such resources to facilitate serving public members who are negatively affected by a civilly-catastrophic event. As used herein, “civilly-catastrophic event” will be understood to refer to an event that substantially and materially disrupts a society's local, regional, and/or national infrastructure and ability to provide in ordinary course for the survival needs of an impacted community in a manner that will likely persist in substantial form for more than a relatively short period of time. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or non-naturally-caused disasters. Examples of natural disasters that are potentially capable of initiating a civilly-catastrophic event include, but are not limited to, severe weather-related events (such as hurricanes, tsunamis, extreme droughts, widespread or unfortunately-targeted tornadoes, extreme hail, rain, and the like, flooding, and so forth), severe geological events (such as earthquakes, volcanic activity, and so forth), severe astronomical-based events (such as extreme solar flares, collisions with comets or large asteroids, and so forth), severe environmental events (such as widespread uncontrolled fire, severe invasive species events, or the like), severe disease-based events such as global or regional pandemics, a severe natural shortage of a life-sustaining resource, a naturally-occurring ongoing and relatively widespread threat to human life, and so forth, to note but a few.

Examples of non-naturally-caused disasters capable of initiating a civilly-catastrophic event include both unintended events as well as acts of war, terrorism, madness or the like. Examples of non-naturally-caused disasters capable of such potential scale include, but are not limited to, nuclear-related events (including uncontrolled fission or fusion releases, radiation exposure, and so forth), acts of war, terrorism, and related aggression, the accidental or intentional release and public dispersal of a severe environmentally borne danger such as deadly or otherwise disruptive biological or chemical agents or creations, a circumstance that results in exposure to a dangerous mutagenic influence, and so forth.

As noted above, the preceding steps are taken based at least in part upon an expectation, at some point, of being at least partially reimbursed by receipt of governmentally-provided consideration. With this in mind, if desired, this process 100 will optionally accommodate establishing 104 a consideration-based arrangement with one or more governments, prior to a civilly-catastrophic event having occurred, to permit their corresponding citizens to access the aforementioned survival resource. Such an arrangement can be established with a national government and/or lesser governmental bodies (such as state, province, or territorial governments, county governments, municipal governments, and so forth) as appropriate. By one approach, such an arrangement will provide for future compensation in the event that the provided resources are actually accessed during a time of need. If desired, however, a full or partial payment in this regard can be proffered and accepted 106 from one or more corresponding governmental entities 203 in advance of any civilly-catastrophic event having occurred as illustrated in FIG. 2.

As alluded to above, the aforementioned private entity may also be involved with designing, providing, maintaining, and/or offering private civil defense shelters, private civil defense transport services, private civil defense rescue services, and/or the development and/or providing of privately developed customized instructions regarding appropriate survival actions to take in response to a civilly-catastrophic event on a subscription basis to corresponding authorized beneficiaries of such subscriptions. Numerous examples of such services are set forth in the various patent applications noted above. The present teachings will readily optionally accommodate accepting 105 consideration-based private civil security subscriptions that permit civilly-catastrophic event-based access to the same survival resource as is otherwise provided herein by corresponding authorized beneficiaries 204 as is illustrated in and suggested by FIG. 2.

So configured, those skilled in the art will appreciate that one or more survival resources are provided and held in readiness for public members against the possibility of a civilly-catastrophic event occurring. If and when such an event then occurs, this process 100 will then facilitate providing 108 access to this survival resource by such public members in exchange for the aforementioned governmentally-based consideration. Such access can be limited or unlimited as desired. For example, such a right of access may comprise a time-limited right of access, an event-limited right of access (as when the right of access expires upon the occurrence of some subsequent event of natural or human origin), a right of access that is predicated upon a series of periodic payments, or a right of access that is predicated upon a one-time payment, to note but a few examples in this regard.

If desired, these teachings will also optionally accommodate conditioning 107 such access upon one or more other conditions of relevance. For example, such access can be additionally conditioned upon some privately-based consideration (as when the governmental portion comprises only a partial payment or when the public member is not included within a group of recognized beneficiaries of such governmental largess). In such a case, if desired, the privately-based consideration can comprise, at least in part, a barter transaction that is based upon things or services of value other than coins or currency. It would also be possible for such privately-based consideration to be provided, in full or in part, as an act of philanthropy by an interested benefactor.

As perhaps a broader example of a condition, the aforementioned access can be conditioned upon receiving at least a representation (such as a written and signed representation) in certain regards from the public members. Such a representation might comprise, for example, a representation that a given public member will be responsible for payment in the event they are not fully or even partially eligible for governmental support in this regard. In such a case, for example, a given public member can gain present access to the survival resource pending a confirmation of their right to have such access in exchange for the aforementioned governmentally-based consideration. In the event their presence is not fully covered in this way they can instead be, for example, personally liable for the corresponding payments as relate to their present access rights. Such a representation can be signed, for example, by the given member of the public who seeks such access and/or can be signed (or co-signed) by a third party such as a relative, a traveling companion, an employer, a benefactor having charitable intent, and so forth.

As yet another example, the aforementioned right of access can also be conditioned upon requiring the public members to agree to adhere to a predetermined standard of behavior. This can comprise, for example, agreeing to avoid a listing of unacceptable behaviors as are set forth in corresponding specifications. Such an agreement can further comprise, if desired, one or more enumerated specific agreed-to consequences of failing to adhere to such a standard. The consequences themselves can vary greatly with the application setting, of course, but some relevant examples likely include denying the misbehaving individual further access to the survival resource. When the survival resource comprises, in part, the aforementioned town, this can include, if desired, being forced to leave the town. Another example might be to impose supplemental limitations with respect to an individual's freedom of movement (via, for example, house arrest or time spent in a secured, confined setting such as a jail cell) and/or their freedom of action (via, for example, prohibitions regarding certain areas that are now off limits). As yet another example, increased consideration may be required (either from the misbehaving individual or some other source or sponsor) as a condition of their continued right to access the survival resource.

As yet another condition that might be considered in this regard, incoming public members might be required to provide identifying information regarding themselves. This can comprise, for example, their name, biometrically-based identifying characteristics (such as, but not limited to, their photographic image, their asperity patterns (such as fingerprints, palm prints, or the like), their retinal patterns, their DNA, and other information of like biological uniqueness), information regarding a personally-carried code (such as a personal identification number (PIN) that the individual selects or which is assigned to them), and so forth. This can also comprise government issued identifiers such as, but not limited to, drivers licenses, social security information, passports, and so forth. Such information can be used to maintain records regarding who had access to the survival resource which may, in turn, comprise an important part of determining the governmentally-based consideration to be paid.

At least some incoming public members may also be required to have or carry other identifying material such as a radio frequency identification tag that is worn or implanted or an optical code (such as a bar code) that is worn (such as, for example, an identification bracelet, necklace, or the like). This can also comprise a badge that is worn, permanently or temporarily, by such public members (where a “badge” will be understood to refer to a wide range of indicia and/or media carriers). Such material and/or the aforementioned identifying information can, in turn, be used to track access to the survival resources offered by the private entity. For example, automatic or other records can be maintained using such information to note the facilities that are visited and/or used by a given individual, their presence at meals, and so forth. This information, in turn, can be used when determining a precise amount that might be owed to the private entity by a corresponding governmental entity.

As yet one further example of a condition that may be imposed upon public members seeking to access the survival resource, some or all of the incoming public members may be required to receive one or more specific medical services. These medical services can comprise, for example, a physical examination, one or more inoculations, an eye examination, a dental examination, and so forth. It would also be possible, for example, to examine such individuals to detect their degree of exposure to one or more dangerous conditions (such as ionizing radiation, dangerous chemical or biological agents, and so forth).

To the extent that the private entity has earlier provided non-survival resources as noted above, this process 100 will also support now providing access 109 to such non-survival resources by the public members. In some cases it is possible that governmental consideration will be forthcoming to provide access to survival resources but not to non-survival resources. In such a case, supplemental consideration may be required before a given public member can access such non-survival resources.

As noted above, these teachings will support the taking one or more of these actions contemporaneously with the acceptance of consideration-based private civil security subscriptions. In such a case, this process 100 will then further optionally accommodate also providing access 100 to the survival resource (and/or non-survival resource) for the authorized beneficiaries of such subscriptions.

When the survival resources comprise, at least in part, the aforementioned town, for various purposes it may be useful to optionally conduct 111 a census of the town to determine, at a minimum, its corresponding number of occupants and/or other characterizing group or individual demographics. Such a census can be conducted, for example, as people enter the town and/or at other times, in other ways, subsequent thereto. Such information can help to inform the determination of a proper amount of consideration to be offered by corresponding governmental entities. It would also be possible to publish 112 at least portions of such a census in a manner that provides such information to the inhabitants of the town. Such publication could be effected, for example, via the media facilities 309 mentioned earlier. Such information could be used by the public members, for example, to identify and locate loved ones, business associates, and so forth. It would also be possible to publish at least some of this information to permit persons external to the town 300 to access and view such information and thereby determine whether persons of interest to them were present at the town 300.

As noted above, the aforementioned governmentally-based consideration might be provided in whole, or in part, prior to the occurrence of any triggered civilly-catastrophic event. These teachings will also readily accommodate, however, receiving 113 such consideration, again in whole or in part, subsequent to the occurrence of a civilly-catastrophic event that triggers the described access to the survival resource(s). This consideration may comprise a flat amount, an amount that is based upon the number of public members who are accessing the survival resource, an amount that is based upon a quantity of survival resources that have been so accessed, or any other metric or parameter of choice.

So configured, members of the public can have access to one or more survival resources in the event of a civilly-catastrophic event. When delivered in the form of a town, the transition from ordinary life to evacuee renders the process itself, as well as the many follow-on actions and events that are likely to occur, considerably easier and conducive to a sense of normalcy and retained control. Furthermore, governments are able to attain the benefits of expert planning, expert design, and expert execution for their citizenry in such regards without having to grow the size of government or acquire those skill sets in the public sector.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one example in this regard, one or more of the provided survival resources (and/or the non-survival resources when provided) can be supplied in a manner that tends to assure at least full redundancy. In the case where these teachings include the use of a substantially unpopulated town, this can comprise, for example, provide two (or more) substantially comparable independent water supplies, two power supplies, two sanitation treatment plants, two food storage areas that each contain a quantity of food that is intended to be fully sufficient to meet the planned needs of the facility, two fully supplied medical facilities, and so forth. So configured, survival resources are provided in an over-engineered, overstocked, and/or over-designed manner that may ultimately prove expedient when facing the exigencies of a civilly-catastrophic event. As another example in this regard, the governmentally-provided consideration can comprise something other than a direct form of consideration; for example, this consideration may take the form of a tax abatement, a tax minimization opportunity, a tax credit, or the like. As yet another example in this regard, these teachings can provide for provision of a certification for public members who accessed the at least one survival resource that such access occurred. This can comprise, for example, providing the certification in response to a specific request for the certification (where the request stems from a corresponding public member, a governmental entity, an interested third party, or the like). These teachings will also optionally provide for automatically providing such a certification to a predetermined entity (such as, but not limited to, a governmental entity such as a governmentally entity that is going to be providing the aforementioned governmental-based consideration).

I claim:

1. A method comprising:
at a private entity:
prior to a civilly-catastrophic event having occurred:
providing at least one survival resource;
holding the at least one survival resource in readiness to facilitate serving public members affected by a civilly-catastrophic event;
in response to a civilly-catastrophic event having occurred:
providing access to the at least one survival resource by public members in exchange for governmentally-based consideration.

2. The method of claim 1 wherein the private entity comprises at least one of:
a for-profit enterprise;
a not-for-profit enterprise.

3. The method of claim 1 wherein providing access comprises providing at least one of:
a time-limited right of access;
an event-limited right of access;
a right of access predicated upon a series of periodic payments;
a right of access predicated upon a one-time payment.

4. The method of claim 1 wherein providing at least one survival resource comprises providing at least one of:
food;
hydration supplies;
shelter;
clothing;
transport away from a location of substantial civil distress;
rescue from civilly-catastrophic event-based substantially immediate threats;
environmentally borne threat abatement;
medical facilities.

5. The method of claim 1 wherein the civilly-catastrophic event comprises an event that substantially disrupts society's infrastructure and ability to provide at least one life-sustaining resource.

6. The method of claim 5 wherein the civilly-catastrophic event is one that is likely to persist in substantial form for more than a predetermined period of time.

7. The method of claim 5 wherein the civilly-catastrophic event comprises at least one of:
a natural disaster;
a non-naturally-caused disaster.

8. The method of claim 7 wherein the natural disaster comprises at least one of:
a severe weather event;
a severe geophysical event;
a severe astronomical event;
a severe disease-based event;
a severe agricultural event;
a severe natural shortage of a life-sustaining resource;
a naturally-occurring ongoing and relatively widespread threat to human life.

9. The method of claim 7 wherein the non-naturally-caused disaster comprises at least one of:
an intentional act of aggression;
an unintentional act of aggression;
an unintended event that results in public dispersal of a severe environmentally borne danger;
an event that results in widespread exposure to a mutagenic danger.

10. The method of claim 1 wherein the private entity provides private civil defense services to parties other than the public members.

11. The method of claim 10 wherein the private civil defense services comprise providing at least one of:
a private civil defense shelter;
private civil defense survival supplies;
a private civil defense transport service;
a private civil defense rescue service;
privately developed customized instructions regarding appropriate survival actions to take in response to a civilly-catastrophic event.

12. The method of claim 1 further comprising:
prior to a civilly-catastrophic event having occurred:
providing at least one non-survival resource;
holding the at least one non-survival resource in readiness to facilitate serving public members affected by a civilly-catastrophic event;
in response to a civilly-catastrophic event having occurred:
providing access to the at least one non-survival resource by the public members.

13. The method of claim 12 wherein providing at least one non-survival resource comprises providing office facilities such that at least some dispossessed public members have an opportunity to continue to ply their profession.

14. The method of claim 13 wherein providing office facilities comprises providing at least one of:
a computer;
an extranet interface;
a two-way long distance voice-based communication apparatus;
a printer;
a scanner;
a facsimile transceiver;
an image copier;
a typewriter;
electricity;
long distance voice communications.

15. The method of claim 13 wherein providing office facilities comprises providing at least one of:
individual private office space;
individual open office space;
shared office space;
office furniture;
group meeting facilities;
administrative support;
office supplies.

16. The method of claim 12 wherein providing at least one non-survival resource comprises providing insurance claim adjustment facilities such that at least some of the public members are able to conveniently process their corresponding insurance claims as relate to losses they have incurred as a result of the civilly-catastrophic event.

17. The method of claim 12 wherein providing at least one non-survival resource comprises providing parking facilities for vehicles used by the public members to reach the at least one survival resource.

18. The method of claim 17 wherein the parking facilities comprise secure parking facilities that are configured and arranged to substantially discourage unauthorized parties from making unauthorized access to vehicles contained in the parking facilities.

19. The method of claim 17 wherein providing parking facilities comprises providing valet services to place the vehicles used by the public members in the parking facility and to retrieve the vehicles that have been placed in the parking facility.

20. The method of claim 12 wherein providing at least one non-survival resource comprises providing financing services facilities such that at least some of the public members are able to arrange for financing.

21. The method of claim 20 wherein providing financing services facilities comprises providing disaster area-based loan processing facilities such that at least some of the public members are able to conveniently process their corresponding disaster area-based loans as relate to circumstances they have endured as a result of the civilly-catastrophic event.

22. The method of claim 12 wherein providing at least one non-survival resource comprises providing voting facilities such that at least some of the public members are able to exercise their voting franchise notwithstanding their having been dispossessed as a result of the civilly-catastrophic event.

23. The method of claim 22 wherein the voting facilities comprise, at least in part, absentee voting facilities.

24. The method of claim 12 wherein providing at least one non-survival resource comprises providing accredited academic instruction for school age public members.

25. The method of claim 1 wherein providing at least one survival resource comprises providing a substantially unpopulated town.

26. The method of claim 25 wherein providing a substantially unpopulated town comprises providing at least some of:
residential facilities;
governmental facilities;
public health, safety, and welfare facilities;
food distribution facilities;
recreational facilities;
educational facilities;
food preparation facilities;
storage facilities;
industrial facilities;
professional facilities;
an inclusive two-way communications infrastructure;
entertainment and leisure facilities.

27. The method of claim 26 wherein providing a substantially unpopulated town comprises providing a limited standing population of persons.

28. The method of claim 27 wherein the limited standing population of persons comprises, at least in part, persons designated to facilitate at least one the facilities of the substantially unpopulated town.

29. The method of claim 28 further comprising:
in anticipation of a civilly-catastrophic event, at least temporarily increasing a number of persons inhabiting the substantially unpopulated town such that the facilities of the substantially unpopulated town are rendered in an improved state to service dispossessed persons who arrive at the substantially unpopulated town in response to a civilly-catastrophic event having occurred.

30. The method of claim 26 further comprising, in response to the civilly-catastrophic event having occurred, using at least some of the public members to facilitate at least one of the facilities.

31. The method of claim 30 wherein using at least some of the public members to facilitate at least one of the facilities comprises, at least in part, at least one of:
interviewing at least some of the public members regarding their qualifications to assist with at least one of the facilities;
testing at least some of the public members regarding their qualifications to assist with at least one of the facilities;
training at least some of the public members to assist with at least one of the facilities.

32. The method of claim 25 wherein providing a substantially unpopulated town comprises providing a substantially unpopulated town that is capable of reasonably accommodating at least 10,000 of the public members.

33. The method of claim 32 wherein providing a substantially unpopulated town that is capable of reasonably accommodating at least 10,000 of the public members comprises providing a substantially unpopulated town that is capable of reasonably accommodating at least 100,000 of the public members.

34. The method of claim 25 wherein providing a substantially unpopulated town that is capable of reasonably accommodating at least 10,000 of the public members comprises providing the substantially unpopulated town in a substantially rural area.

35. The method of claim 25 wherein providing a substantially unpopulated town that is capable of reasonably accommodating at least 10,000 of the public members comprises a substantially unpopulated town having at least one resident.

36. The method of claim 35 wherein the at least one resident comprises an agent of the private entity.

37. The method of claim 36 wherein the at least one resident comprises an official for the substantially unpopulated town.

38. The method of claim 37 wherein the official comprises at least one of:
a member of a governmental executive branch for the substantially unpopulated town;
a member of a governmental legislative branch for the substantially unpopulated town;
a member of a governmental judicial branch for the substantially unpopulated town;
a member of a governmental public services entity for the substantially unpopulated town.

39. The method of claim 25 wherein providing a substantially unpopulated town comprises providing at least some of:
retail stores;
sports events venues;
a physical fitness center;
entertainment facilities;
a theater.

40. The method of claim 25 wherein providing a substantially unpopulated town comprises providing at least one nationally-recognized brand name dining establishment.

41. The method of claim 25 wherein providing a substantially unpopulated town comprises providing at least one nationally-recognized brand name retail establishment.

42. The method of claim 25 wherein providing a substantially unpopulated town comprises providing at least one nationally-recognized brand name personal services establishment.

43. The method of claim 25 wherein providing a substantially unpopulated town comprises providing at least one nationally-recognized brand name entertainment establishment.

44. The method of claim 25 further comprising, in response to a civilly-catastrophic event having occurred, populating the substantially unpopulated town with the public members to provide a populated town.

45. The method of claim 44 further comprising operating within the populated town at least one of:
a service facility to provide social security benefits services;
a package delivery service;
banking services;
money transfer services;
postal services;
welfare services;
immigration services;
law enforcement services;
bakery services;
salon services;
travel service services;
pharmaceutical services;
grocery services;
hair care services;
laundry services;
dry cleaning services;
florist services;
gift shop services;
grief counseling services;
bill payment services;
an Internet cafe.

46. The method of claim 45 further comprising:
conducting a census of the populated town;
publishing at least portions of the census in a manner that provides such information to the public members.

47. The method of claim 25 further comprising operating a portion of the substantially unpopulated town as a tourist destination pending a need for the substantially unpopulated town to receive public members who have been at least temporarily dispossessed as the result of a civilly-catastrophic event.

48. The method of claim 25 wherein providing a substantially unpopulated town comprises providing a substantially unpopulated town on at least one of:
land;
a floating platform.

49. The method of claim 25 wherein providing a substantially unpopulated town comprises providing a plurality of geographically dispersed substantially unpopulated towns.

50. The method of claim 25 wherein providing a substantially unpopulated town further comprises, in response to a civilly-catastrophic event having occurred, publishing a town news report such that the public members can remain informed of newsworthy events and information.

51. The method of claim 1 further comprising, prior to a civilly-catastrophic event having occurred, establishing a consideration-based arrangement to permit the public members to access the at least one survival resource in response to an occurrence of a civilly-catastrophic event, and wherein providing access to the at least one survival resource by public members in exchange for governmentally-based consideration comprises providing the access as a function, at least in part, of the consideration-based arrangement.

52. The method of claim 51 further comprising:
receiving the governmentally-based consideration from a corresponding governmental entity.

53. The method of claim 52 wherein receiving the governmentally-based consideration from a corresponding governmental entity comprises receiving at least some of the governmentally-based consideration from a corresponding governmental entity prior to a civilly-catastrophic event having occurred.

54. The method of claim 52 wherein receiving the governmentally-based consideration from a corresponding governmental entity comprises receiving at least some of the governmentally-based consideration from a corresponding governmental entity subsequent to the civilly-catastrophic event having occurred.

55. The method of claim 1 wherein providing access to the at least one survival resource by public members in exchange for governmentally-based consideration further comprises providing access to the at least one survival resource by public members in exchange for:
governmentally-based consideration; and
privately-based consideration.

56. The method of claim 55 wherein the privately-based consideration comprises, at least in part, a barter transaction that is based upon things or services of value other than coins or currency.

57. The method of claim 55 further comprising, in response to the civilly-catastrophic event having occurred, conditioning providing the access to the at least one survival resource by a given public member upon at least a representation by the given public member to be responsible for the privately-based consideration.

58. The method of claim 57 wherein the representation comprises, at least in part, a written representation.

59. The method of claim 58 wherein the written representation comprises a written representation that is signed by the given public member.

60. The method of claim 59 wherein the written representation comprises a written representation that is signed by a third party other than the given public member.

61. The method of claim 1 wherein providing access to the at least one survival resource by public members in exchange for governmentally-based consideration further comprises providing the access to the at least one survival resource by a given public member in exchange for a particular representation from the given public member pending confirmation of the given public member's right to have such access in exchange for the governmentally-based consideration.

62. The method of claim 61 wherein the particular representation comprises, at least in part, a promissory note.

63. The method of claim 1 wherein providing access to the at least one survival resource by public members further comprises providing the access only to public members who agree to adhere to a predetermined standard of behavior.

64. The method of claim 63 wherein the predetermined standard of behavior comprises, at least in part, specifications regarding unacceptable behaviors.

65. The method of claim 64 wherein the predetermined standard of behavior further comprises, at least in part, at least one specified agreed-to consequence of failing to adhere to the predetermined standard of behavior.

66. The method of claim 65 wherein the consequence comprises at least one of:
denied access to the at least one survival resource;
supplemental limitations with respect to freedom of movement;
supplemental limitations with respect to freedom of action;
increased required consideration.

67. The method of claim 1 wherein providing access to the at least one survival resource by public members further comprises conditioning the access for a given one of the public members upon obtaining identifying information for the given one of the public members.

68. The method of claim 67 wherein the identifying information comprises at least one of:
a name;
a biometrically-based identifying characteristic;
information regarding a personally-carried code;
government issued identifiers.

69. The method of claim 68 wherein the information regarding a personally-carried code comprises information regarding at least one of:
a radio frequency identification tag;
an optical code;
a badge.

70. The method of claim 67 wherein providing access to the at least one survival resource by public members comprises, at least in part, tracking access to the at least one survival resource using, at least in part, the identifying information to provide access information.

71. The method of claim 70 further comprising determining the governmentally-based consideration as a function, at least in part, of the access information.

72. The method of claim 1 further comprising, in response to a civilly-catastrophic event having occurred, providing facilities to assist the public members to regain presently unavailable identity-related materials.

73. The method of claim 72 wherein the presently unavailable identity-related materials comprise at least one of:
a drivers license;
a social security card;
a disabled-person's placard;
a credit card;
a debit card;
a state identification card;
a medical insurance card;
a firearms identification card;
a firearms concealed carry card.

74. The method of claim 1 further comprising, in response to a civilly-catastrophic event having occurred, providing a particular medical service to substantially all of the public members.

75. The method of claim 74 wherein the particular medical service comprises at least one of:
a physical examination;
an inoculation;
an eye examination;
a dental examination;
an examination to detect exposure to at least one dangerous condition.

76. The method of claim 75 wherein the particular medical service comprises an opportunity to apply for rapid replacement of lost prescription medicines.

77. The method of claim 1 further comprising:
prior to the civilly-catastrophic event having occurred, accepting consideration-based private civil security benefits subscriptions from subscribers to provide access to the at least one survival resource in event of a civilly-catastrophic event;
in response to the civilly-catastrophic event having occurred, permitting authorized beneficiaries of the subscriptions to access the at least one survival resource;
such that both the public members and the authorized beneficiaries have access to the at least one survival resource.

78. The method of claim 1 further comprising:
providing access to at least one workshop where the public members can provide labor as pertains to manufacturing at least one resultant manufactured item.

79. The method of claim 1 further comprising using the labor to offset consideration owed to the private entity.

80. The method of claim 79 further comprising:
receiving a guarantee from a governmental entity regarding an ensured purchase of the at least one resultant manufactured item.

81. The method of claim 1 wherein providing access to the at least one survival resource by public members comprises providing access to shelter that includes sleeping accommodations, wherein the sleeping accommodations comprise at least one of:
a cot;
a bunk bed;
a barracks facility;
a semi-private facility;
a private facility;
a sleeping pad;
a sleeping bag;
loose bedding;
a tatami mat.

82. The method of claim 1 wherein providing access to the at least one survival resource by public members further comprises providing the public members with local credentials;
requiring use of the local credentials to gain access to at least one resource.

83. The method of claim 82 further comprising:
requiring use of the local credentials to leave and re-enter a facility that comprises the at least one survival resource.

84. The method of claim 1 further comprising:
in response to the civilly-catastrophic event having occurred, publishing information regarding the public members who have accessed the at least one survival resource, such that persons other than the public members can review such information.

85. The method of claim 1 further comprising:
in response to the civilly-catastrophic event having occurred, providing a certification for public members who accessed the at least one survival resource that such access occurred.

86. The method of claim 85 wherein providing the certification comprises providing the certification in response to a specific request for the certification.

87. The method of claim 85 wherein providing the certification comprises automatically providing the certification to a predetermined entity.

88. The method of claim 87 wherein automatically providing the certification to a predetermined entity comprises, at least in part, automatically providing the certification to a governmental entity.
